(19) United States
(12) Patent Application Publication
(10) Pub. No.: US 2019/0004672 A1
(43) Pub. Date: Jan. 3, 2019

(54) METHOD OF SELECTING A TYPE OF EYEWEAR AND ELECTRONIC DEVICE

(71) Applicant: ESSILOR INTERNATIONAL, Charenton-Le-Pont (FR)

(72) Inventors: Floriane THIBAULT, CHARENTONLE- PONT Cedex (FR); Clémence VAN VYNCKT, METZ (FR)

(21) Appl. No.: 16/066,529

(22) PCT Filed: Dec. 30, 2015
(86) PCT No.: PCT/IB2015/002597

§ 371 Date: Jun. 27, 2018

(51) Int. Cl. G06F 3/0482

(52) U.S. Cl. CPC G06F 3/0482; G02C 7/10

(57) ABSTRACT

A method and device for selecting a type of eyewear adapted for eye protection of an individual, includes the steps of i) obtaining first data (D1) representative of sensitivity to light intensity of the individual; ii) determining second data (D2; D2′) representative of a characteristic of light intensity liable to surround the individual; iii) computing, using a processor (4) of an electronic device (2), a criterion based on the first data (D1) and the second data (D2; D2′); and iv) selecting the type of eyewear according to the criterion.

### TECHNICAL FIELD OF THE INVENTION

The invention relates to protection of an individual's eyes by eyewear.

More precisely the invention relates to a method of selecting a type of eyewear and to an electronic device.

### BACKGROUND INFORMATION AND PRIOR ART

Document U.S. Pat. No. 8,494,507 describes a mobile terminal having a light sensor for detecting whether a predefined brightness threshold is exceeded and a screen that displays an indication suggesting wearing sunglasses when the threshold is exceeded.

This feature is interesting in that it encourages the use of sunglasses for protecting one's eyes from intense light. However, as it operates on an all-or-nothing basis, it is not adapted when seeking to determine which type of eyewear would be particularly adapted for eye protection of an individual.

### SUMMARY OF THE INVENTION

In this context, the invention provides a method of selecting a type of eyewear adapted for eye protection of an individual, comprising the following steps:
obtaining first data representative of sensitivity to light intensity of the individual;
determining second data representative of a characteristic of light intensity liable to surround said individual;
computing, using a processor of an electronic device, a criterion based on the first data and the second data; and
selecting the type of eyewear according to said criterion.

The selected type of eyewear is thus particularly well suited for the individual in the situation he/she is to experience, as the selection method takes into account both the individual's specificity and his/her environment.

An eyewear comprises for example two ophthalmic lenses and a frame in which said ophthalmic lenses are mounted. The type of eyewear may be selected upon ophthalmic lenses characteristics and/or frame characteristics.

According to possible optional features (which are to be understood in a non-limiting way):
the eyewear attenuates light transmission by at least 10% (or possibly by at least 30%) for said characteristic of light intensity;
the method further comprises a step of displaying an indication of the selected type of eyewear on a screen;
obtaining the first data includes reading the first data in a memory;
the second data is representative of a characteristic of light experienced (e.g. either currently or in the past) by said individual;
the characteristic of light experienced by said individual is measured by a light sensor;
the second data is representative of a characteristic of light forecast to be experienced by said individual;
the characteristic of light forecast to be experienced by said individual (e.g. a UV index) is received from a (remote) server;
the method comprises displaying an indication of the criterion or an indication corresponding to the selected type of eyewear on the screen;
the indication displayed is an alert to recommend said individual to wear the selected type of eyewear, and/or a recommendation to said individual to purchase the selected type of eyewear;
said electronic device is a remote server communicating with a (possibly mobile) terminal of the individual;
said electronic device is a (possibly mobile) terminal of the individual (in which case this terminal may include the screen and/or the memory and/or the light sensor mentioned above);
the terminal is a smartphone or a tablet computer (i.e. a mobile terminal), or a personal computer;
the selection of the type of eyewear is a selection of the ophthalmic lenses of the eyewear and/or a selection of the frames in which ophthalmic lenses will be mounted.

The invention also provides an electronic device comprising a memory for storing first data representative of sensitivity to light intensity of an individual; a module for determining second data representative of light intensity liable to surround said individual; a processor for computing a criterion based on the first data and the second data, and for selecting, based on said criterion, a type of eyewear adapted for eye protection of the individual.

The electronic device may also include a database in which the type of eyewear adapted for eye protection of the individual is selected according to the criterion.

As noted above, the module for determining second data may include a light sensor.

Other features and advantages of the embodiments of the present invention will be better understood upon reading of preferred embodiments thereof with reference to the appended drawings.

### BRIEF DESCRIPTION OF THE DRAWINGS

FIG. 1 schematically shows the main elements of a system wherein the invention could be implemented.

FIG. 2 shows an exemplary method of selecting a type of eyewear in accordance with the invention.

FIG. 3 is an exemplary display on an electronic device of the system of FIG. 1.

### DETAILED DESCRIPTION OF EXAMPLE(S)

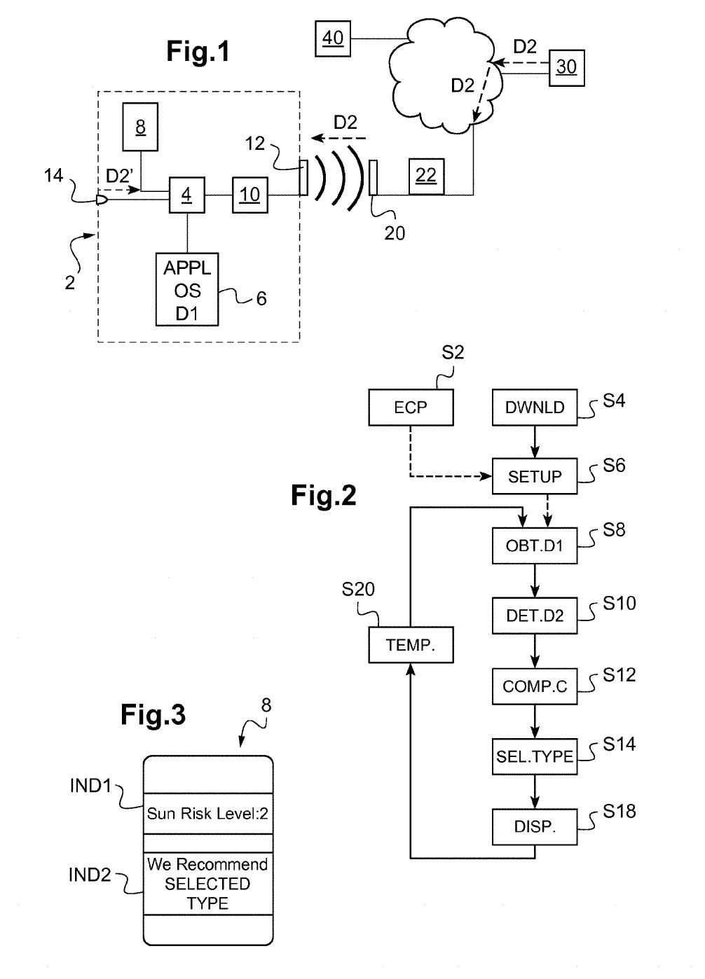

FIG. 1 shows the main elements of a system in which the invention is implemented.

The system of FIG. 1 includes an electronic device 2, here a smartphone. In alternative embodiments, the electronic device 2 could be a tablet computer or a personal computer, for instance.

The electronic device 2 includes a processor 4 (here a microprocessor), at least one memory 6, a screen 8 (here a touchscreen) and a communication circuit 10 connected to an antenna 12.

In the embodiment described here, the electronic device 2 also includes a light sensor 14. Light sensor 14 is for instance sensitive to a particular wavelength range, for instance to visible light or to ultraviolet (UV) light.

Thanks to communication circuit 10, the electronic device 2 can establish a communication with an Internet router 22 (here via a wireless link between an antenna 20 associated with the Internet router 22 and the antenna 12 of the electronic device 2) such that processor 4 can exchange data with remote servers 30, 40 connected to the Internet.

In particular, processor 4 can exchange data with a server 30 delivering forecast information and/or with a server 40 providing applications for execution by processor 4.

According to a possible embodiment, communication circuit 10 establishes a wireless local area network with Internet router 22 (based on the wireless link antenna 12 and antenna 20).

According to another possible embodiment, antenna 20 is situated in a base station of a mobile phone network and communication circuit 10 is designed to establish a radio-frequency communication with this base station and to exchange data over the mobile phone network, for instance conditioned on the presence of credentials in the communication circuit 10 (or in a smart card inserted in the communication circuit 10). In such an embodiment, additional elements connect antenna 20 of the base station to Internet router 22, which elements are not represented for the sake of conciseness.

Memory 6 is a non-volatile memory, here a rewritable non-volatile memory. Memory 6 stores program instructions designed to make processor 4 perform method steps, in particular some of the steps of the method described below with reference to FIG. 2, when these instructions are executed by processor 4.

In the embodiment described here, memory 6 stores an application APPL, whose instructions are designed to make processor 4 perform steps S6 to S20 described below when these instructions are executed by processor 4.

Application APPL has for instance been previously downloaded from server 40 into memory 6, as explained below.

Memory 6 also stores data representing values of parameters used during the execution of application APPL. In particular, memory 6 stores data D1 representative of a level of sensitivity to light intensity of the user of the electronic device 2, as further explained below.

These data were for instance stored during a phase of setting up the application APPL (after it has been downloaded). During this phase, the user was for instance prompted to enter his personal level of sensitivity to light intensity.

This personal level of sensitivity was for instance measured by an Eye Care Professional (ECP), as explained below.

Memory 6 also stores other programs than application APPL. In particular, memory 6 stores an operating system OS designed for execution by processor 4, in particular before application APPL is downloaded from server 40.

FIG. 2 shows an exemplary method of selecting a type of eyewear in accordance with the invention.

In step S2, a level of sensitivity to light intensity of an individual (here the user of the electronic device 2) is determined, for instance with the help of an Eye Care Professional (ECP).

According to a possible embodiment, the individual is in the ECP's premises and undergoes a light intensity sensitivity test. Such a test includes for instance:
measuring the visual acuity of the individual in standard light conditions;
subjecting the individual to intense light (i.e. dazzling the individual);
measuring the time needed for the individual to recover the previously measured visual acuity;
determining a level of sensitivity to light intensity by comparing the measured recovery time to at least one standard recovery time.

Other tests are described in French patent application 1550383.

The test can also include a step during which the individual fills in a questionnaire, with questions on age, usual activities (indoor, outdoor, night, driving . . . ), ocular diseases . . . . The level of light intensity sensitivity can then be determined for instance depending on responses given by the individual in the questionnaire (possibly in addition to depending on measurements described above).

In step S4, the individual, who is also here the user of the electronic device 2, downloads application APPL from server 40, for instance by entering specific commands on the touchscreen 8 of the electronic device 4 while the operating system OS (or another application dedicated to application downloading from server 40) executes on processor 4.

In step S6, application APPL executes on processor 4 and prompts the user of the electronic device 2 to enter his/her own level of sensitivity to light intensity. Prompting the user to enter his/her level of sensitivity is performed only in a set-up phase, for instance when application APPL first executes on processor 4, or when it is specifically requested by the user to change the level value (for instance when the user selects a corresponding menu or virtual button on touchscreen 8).

The user thus enters (here via touchscreen 8) the level of sensitivity to light intensity determined in step S2 described above and corresponding data D1 are then stored in memory 6.

Once application APPL is configured, electronic device 2 is ready for use in selecting a type of eyewear adapted for eye protection of the user, as now explained.

In step S8, data D1 representative of sensitivity to light intensity of the individual (here the user) are obtained.

In the embodiment described here, data D1 are read by processor 4 from memory 6, where these data have been previously stored as explained above (step S6).

According to a possible variation, data D1 could be retrieved (i.e. downloaded) from a server, for instance a server managed by the ECP in the premises of whom the test of step S2 was performed.

In step S10, data D2, D2′ representative of a characteristic of light intensity liable to surround the individual (here the user) are determined.

According to a first embodiment, data D2 are representative of a characteristic of light forecast to be experienced by the individual, for instance over the next 24 hours.

This characteristic of light is for instance maximum light intensity forecast over a given period of time, for instance the next 24 hours. According to possible variations, the characteristic may be instantaneous intensity or average intensity over a predetermined period of time This characteristic of light may relate to visible light and/or to ultraviolet (UV) light. The characteristic of light may also be a spectral density in a predetermined wavelength range.

Such data D2 are for instance received (i.e. downloaded) from forecast server 30. Forecast server 30 selects data D2 corresponding to a relevant location for instance the current location of the electronic device 2 (this current location may be indicated in a request for data D2, such request being sent from electronic device 2 to forecast server 30). Such data D2 are for instance a UV index received by processor 4 (from forecast server 30 and through communication circuit 10) together with weather forecast information.

Such data D2 may be determined based on an activity or a journey planned by the user, for instance as per an electronic agenda stored in the electronic device 2. In this case, data D2 include for instance a UV index forecast for a place where the user is travelling according to his/her electronic agenda. Data D2 may include different light sources for the activities the user will have according to his/her electronic agenda during the day: indoor activities with artificial lighting, use of digital displays, outdoor activities in bright sun, driving at sunrise or sunset, frequent moves from inside to outside.

According to a second embodiment, data D2′ are representative of a characteristic of light experienced by the individual, at the time considered, or at a certain moment in the past, or over a period of time in the past.

In the embodiment described, light sensor 14 measures a current value of light intensity in the environment surrounding electronic device 2 and data D2′ is representative of the measured light intensity value.

According to a third embodiment, data representative of a characteristic of light intensity liable to surround the individual include both data D2 representative of a characteristic of light forecast to be experienced by the individual and data D2′ representative of a characteristic of light experienced by the individual.

In step S12, processor 4 computes a criterion C based on the data D1 representative of sensitivity to light intensity of the individual (obtained in step S8) and on the data D2, D2′ representative of a characteristic of light intensity liable to surround the individual (determined in step S10).

The criterion C is for instance a level of risk for the concerned individual when surrounded by light characterised by data D2, D2′ (taking into account the sensitivity to light intensity of this individual as represented by data D1).

In step S14, processor 4 selects a type of eyewear based on the criterion C computed in step S12.

This selection is made for instance within a list of possible types, each possible type including for instance one or several of the following features: tinted, gradient tinted, temporarily tinted (photochromic or electrochromic), polarizing, filter. In particular, the filter may be a blue light filters which attenuates at least partially harmful blue light in the range of 400 nm to 460 nm. The filter may be also a blue light filter which attenuates at least partially all visible light except in the chronobiologic blue light range of 460 nm to 520 nm. The filter may be also a yellow-green filter which attenuates at least partially visible light in the range of 530 to 650 nm, where human eye is most sensitive.

In addition, the selection of eyewear may be completed by an indication on characteristics of the frames in which selected eyewear will be mounted. In particular, frame characteristics may be chosen among frame shape such as wrap or high curve frames or frame size such as large lens diameter. Temple size may also be selected to be large. Rim thickness may also be selected to be large, or having a shape that do not reflect light towards wearer's eyes or a texture that scatters light in all directions. Wrap frames, large lens diameters, large temples and rim structure do contribute in shielding light coming from side or back of the wearer. Colour and/or transparency and/or light reflection of frame material may be also chosen so as to provide a comfortable light surrounding for the wearer and limit light exposition of wearer's eyes. For instance, a range of values is associated to each possible type in the list and the selection is made by selecting the possible type associated to a range encompassing the criterion C computed in step S12.

The concerned types correspond to eyewear designed to attenuate light transmission by at least 10% (and possibly by at least 30%) in a given wavelength range (for instance for visible light and/or for UV light).

The list of possible types is for instance stored as a database in memory 6 (as data relating to application APPL, these data having possibly been downloaded from server 40 together with application APPL).

The database containing the list of possible types of eyewear may be updated regularly to account for new types of eyewear. This update may be downloaded from server 40 together with application APPL.

According to a possible variation, the list of possible types is stored as a database in a remote server. In this case, the selection of the type of eyewear may be performed by a processor of this remote server based on the criterion C (received from processor 4 via communication circuit 10). The selected type is then transmitted from the remote server to processor 4 (via communication circuit 10). In this case, the list of possible types of eyewear may be updated directly on the remote server.

In step S18, processor 4 controls touchscreen 8 such that touchscreen 8 displays an indication of criterion C (in particular when this criterion is a level of risk as mentioned above) and/or an indication corresponding to the type of eyewear selected in step S16.

FIG. 3 shows an exemplary display on touchscreen 8, including an indication IND1 of criterion C and an indication IND2 corresponding to the selected type of ophthalmic lens.

The indication corresponding to the selected type of eyewear may for instance be an alert to recommend to the individual to wear the selected type of ophthalmic lens, or a recommendation to said individual to purchase the selected type of ophthalmic lens.

Processor 4 may also control touchscreen 8 to display the user's personal sensitivity index (corresponding to data D1 stored in memory 6), the characteristic of light intensity represented by data D2, D2′ (i.e. the UV index received from the forecast server 30 and/or the light intensity measured by light sensor 14) and/or a remaining UV capital. The remaining UV capital is for instance computed by processor 4 by cumulating UV index over a given period of time (e.g. year to date) and by deducting this cumulated value from a predetermined value (corresponding for instance to the recommended cumulated UV capital over a year).

Steps S8 to S18 and the resulting display of the above mentioned indication(s) may be performed upon the user selecting application APPL (e.g. by touching touchscreen 8 on an icon corresponding to application APPL).

Steps S8 to S18 and the resulting display of the above mentioned indication(s) may also be performed periodically. The display of the above mentioned indication(s) may then be performed as a notification superimposed on the image currently displayed by touchscreen 8.

According to a possible embodiment, steps S8 to S12 are performed periodically, but steps S14 and S18, including the display of the indication of criterion C and/or the indication of the selected type of ophthalmic lens, are performed only if the criterion C (e.g. the level of risk) is above a predetermined level (which may be stored in memory 6).

When the steps described above are performed periodically, step S18 is followed by a step S20 during which processor 4 performs other tasks while awaiting the next occurrence of the method described here and, after a predetermined length of time, loops back to step S8 to perform a new occurrence of this method.

In the embodiments that have just been described, the steps of the selection method were mainly performed by processor 4 of electronic device 2, generally resulting from the execution of application APPL by processor 4.

According to possible variations, some of these steps may be performed by a processor of a remote server in communication with electronic device 2.

1. A method of selecting a type of eyewear adapted for eye protection of an individual, comprising the following steps:
obtaining first data representative of sensitivity to light intensity of the individual;
determining second data representative of a characteristic of light intensity liable to surround said individual;
computing, using a processor of an electronic device, a criterion based on the first data and the second data; and
selecting the type of eyewear according to said criterion.

2. The method according to claim 1, wherein the eyewear attenuates light transmission by at least 10% for said characteristic of light intensity.

3. The method according to claim 1, further comprising a step of displaying an indication of the selected type of eyewear on a screen.

4. The method according to claim 1, wherein obtaining the first data includes reading the first data in a memory.

5. The method according to claim 1, wherein the second data is representative of a characteristic of light experienced by said individual.

6. The method according to claim 1, wherein the second data is representative of a characteristic of light forecast to be experienced by said individual.

7. The method according to claim 1, comprising a step of displaying an indication of the criterion or an indication corresponding to the selected type of eyewear on the screen.

8. The method according to claim 7, wherein the indication displayed is an alert to recommend said individual to wear the selected type of eyewear.

9. The method according to claim 7, wherein the indication displayed is a recommendation to said individual to purchase the selected type of eyewear.

10. The method according to claim 1, wherein said electronic device is a remote server communicating with a terminal of the individual.

11. The method according to claim 1, wherein said electronic device is a terminal of the individual.

12. The method according to claim 1, wherein the selection of the type of eyewear is a selection of the ophthalmic lenses of the eyewear and/or a selection of the frames in which ophthalmic lenses will be mounted.

13. An electronic device comprising:
a memory for storing first data representative of sensitivity to light intensity of an individual;
a module for determining second data representative of light intensity liable to surround said individual;
a processor for computing a criterion based on the first data and the second data, and for selecting, based on said criterion, a type of eyewear adapted for eye protection of the individual.

14. The electronic device according to claim 13, further comprising a database in which the type of eyewear adapted for eye protection of the individual is selected according to the criterion.

15. The electronic device according to claim 13, wherein said module for determining second data includes a light sensor.

16. The electronic device according to claim 14, wherein said module for determining second data includes a light sensor.

17. The method according to claim 1, further comprising:
a step of displaying an indication of the selected type of eyewear on a screen, and
a step of displaying an indication of the criterion or an indication corresponding to the selected type of eyewear on the screen,
wherein the eyewear attenuates light transmission by at least 10% for said characteristic of light intensity,
wherein obtaining the first data includes reading the first data in a memory,
wherein the second data is representative of a characteristic of light experienced by said individual,
wherein the indication displayed is an alert to recommend said individual to wear or purchase the selected type of eyewear.

18. The method according to claim 1, further comprising:
a step of displaying an indication of the selected type of eyewear on a screen, and
a step of displaying an indication of the criterion or an indication corresponding to the selected type of eyewear on the screen,
wherein the eyewear attenuates light transmission by at least 10% for said characteristic of light intensity,
wherein obtaining the first data includes reading the first data in a memory,
wherein the second data is representative of a characteristic of light forecast to be experienced by said individual.
wherein the indication displayed is an alert to recommend said individual to wear or purchase the selected type of eyewear.
